(19) United States
(12) Patent Application Publication
(10) Pub. No.: US 2012/0281417 A1
(43) Pub. Date: Nov. 8, 2012

(54) DIRECTIONAL LIGHT SOURCE DEVICE

(75) Inventors: Ghing-Cherng Sun, Jhongli City (TW); Shih-Peng Chen, Kuei San (TW); Ching-Chuan Shiue, Kuei San (TW); Li-Fan Lin, Kuei San (TW); Shuang-Chao Chung, Jhongli City (TW); Shuang-Hau Yang, Jhongli City (TW)

(73) Assignee: National Central University & Delta Electronics, Inc.

(21) Appl. No.: 13/448,535

(22) Filed: Apr. 17, 2012

(30) Foreign Application Priority Data
May 6, 2011 (TW) 100115861

(51) Int. Cl. F21V 13/04; F21V 13/12; F21V 7/08; F21V 7/06; F21V 7/04; F21V 13/08

(52) U.S. Cl. 362/296.01

(57) ABSTRACT

A highly directional light source device, more specifically, a light emitting element electrically connected on a substrate to produce light, and one interior having a photon recycler with a reflective surface, covered and set on one side of this substrate, and an opening set in the center of the top of the cover which corresponds with the light emitting element, thereby allowing the light from the light emitting element to be directly emitted out the opening, and then to be reflected back to the light emitting element through the reflective surface of the photon recycler, and after light is reflected or refracted according to the structure of the light emitting element, again through the opening the light is emitted onto the photon recycler, thereby achieving increased Étendue of the highly directional light source device and achieving the goal of effective light emission.

### BACKGROUND OF THE INVENTION

1. Field of the Invention

The present invention relates to a highly directional light source device, in particular, a highly directional light source device capable of increasing the Étendue and light emission efficiency.

2. Description of Related Art

Please look at FIG. 1, a conventional first light source device 1 constructed from one circuit board 11, one light emitting element 12, one reflective shield 13 and an optical fiber structure 14. This light emitting element 12 is electrically connected to one top surface of the circuit board 11 and reflective shield 13 covers the circuit board 11. The light emitting element 12 is enclosed inside, and an opening 131 is set in the center of the top of this reflective shield 13. Optical fiber structure 14 is placed into opening 131 so that one end of this optical fiber structure 14 is placed on one surface of this light emitting element 12. This optical fiber structure 14 has a transparent hollow body, so when this light emitting element 12 emits a light source which is refracted through this optical fiber structure 14, and again reflected back through this reflective shield 13, it causes this light source to reflect back to the surface of light emitting element 12 and again to be reflected. Finally the light source is guided out through this optical fiber structure 14, or after this light source is reflected through this optical fiber structure 14, this light source is then directly guided out. Utilizing this method allows for all the light source produced by the light emitting element 12 to be guided to the outside of this reflective shield 13, and causes this light source to be guided by this optical fiber structure 14. This produces an optical waveguide, and also allows conventional light source device 1 to proceed with guiding this optical waveguide out reflective shield 13 through this optical fiber structure 14.

This conventional first light source device 1 mainly uses this optical fiber structure 14 to convert all produced light source from light emitting element 12 to an optical waveguide, and to guide and send this optical waveguide to the outside. This conventional first light source device doesn't increase the Étendue and light efficiency of the light source produced from light emitting element 12.

Please look at FIG. 2a, which is the first embodiment of a conventional second light source device 3. This conventional second light source device 3 is constructed from one substrate 31, one light emitting element 32, two contact electrodes 33a and 33b, one wire 34, one light collector 35, and one optical fiber 36. These two contact electrodes 33a and 33b are set on this substrate 31, and this light emitting element 32 connects electrically to the first contact electrode 33a. Thereafter through this wire 34 the light emitting element 32 is then connected electrically to the second contact electrode 33b, thereby causing the light emitting element 32 to convert the electrical energy received from these contact electrodes 33a and 33b to light energy, and thus producing a light source. After the light is collected by the light collector 35 which is set on, and covers, the outside periphery of this light emitting element 32, the light is emitted to optical fiber 36 on the open end of light collector 35, and the light is emitted out through optical fiber 36, or the light is directly emitted out through the open end of light collector 35.

Please look at FIG. 2b which shows a second embodiment of conventional second light source device 3, wherein this optical fiber 36 is changed to optical fiber 36a which has a set thickness. This optical fiber 36a is connected to light collector 35 through a connector 37. A supporting structure 38 is added to two sides of this optical fiber 36a. This supporting structure 38 is secured to foundation plate 31 by bonding material which conducts heat, so as when light emitting element 32 produces heat, the heat is conducted to the supporting structures 38 which proceed to disperse the heat.

Looking at FIGS. 2a and 2b it can be seen that all the light from light emitting element 32, after going through and being collected by light collector 35, the light then goes through optical fiber 36 and 36a and the light is then emitted out. Utilizing this method has the following drawbacks:

1. The divergence angle at which the light is emitted is restricted.

2. The area of light emitted is increased.

3. Therefore this leads to the Étendue being unchanged or the Étendue being too large and thus being Étendue that is not required.

Please look at FIGS. 3a and 3b which shows a conventional third light source device 4 assembled from one light emitting element 41 and one reflector 42. The light produced by light emitting element 41 is reflected off reflector 42 and guided to an optical fiber 43 (as shown in FIG. 3b). After this light is guided to this optical fiber 43, this optical fiber 43 outputs this light to a light source recycling cavity 44 (as shown in FIG. 3b), whereby a part of this light is guided to a wavelength conversion layer 45 (as shown in FIG. 3b). The remaining light is again collected and recycled by the light source recycling cavity 44, and this recycled light is guided to a selected layer 46 of the optical wavelength. This optical wavelength selected layer 46 allows the original wavelength to pass through, and after reflecting and converting this original wavelength, this converted wavelength of the light is again output. Therefore the main role of conventional third light emitting device is to proceed with wavelength conversion.

Therefore how to provide a light source device to increase the Étendue and effective light emission of the light is an important topic.

### SUMMARY OF THE INVENTION

One purpose of the present invention is to provide a highly directional light source device, which includes a light emitting element connected on a substrate, a photon recycler with a reflective surface set on and covering one side of the substrate and accommodates the light emitting element inside, and an opening set in the center of the top of the photon recycler which corresponds with the light emitting element, thereby allowing the light from the light emitting element to be directly emitted out of the photon recycler through the opening and then to be reflected back to the light emitting element through the reflective surface of the photon recycler. As light is reflected or refracted from the structure of the light emitting element, the light is emitted again through the opening and onto the photon recycler, thereby achieving increased Étendue of the highly directional light source device and achieving the goal of effective light emission.

Another purpose of the present invention is to provide a highly directional light source device, which includes a light condensing element set around the outer edge of the light emitting element and covers the light emitting element inside, and this light emitting element produces large divergent angle light rays. This large divergent angle of light is reflected from the photon recycler to the light condensing element, and further reflected from the light condensing surface of the light condensing element, and produces a small offset which forms small angle light rays of the divergent light to the light emitting element. The light is then reflected or refracted through the interior structure of the light emitting element. The light condensing element then condenses the scattered light, and emits the light out of the opening of the photon recycler, thereby achieving the goal of increasing the efficiency of light emission of the highly directional light source device.

Another additional purpose of the present invention is to provide a highly directional light source device, which includes a light conversion element and a microstructure scattering layer. This light conversion element is set at the opening of the photon recycler, and this microstructure scattering layer is set on one side of the substrate, both of which are used to improve the Étendue and the efficiency of the light emission of the highly directional light source device.

The technical means to accomplish the above mentioned is: a substrate; a light emitting element electrically connected on the substrate to produce a light; a photon recycler set on one side of the substrate, internally having a reflective surface for reflecting the light and covering the light emitting element and setting an opening which corresponds with the central part of the top of the light emitting element.

### BRIEF DESCRIPTION OF THE DRAWINGS

The invention, as well as its many advantages, may be further understood by the following detailed description and drawings in which:

FIG. 1 is a structure diagram showing a conventional first light source device.

FIG. 2a and FIG. 2b are the structure diagrams showing a conventional second light source device.

FIG. 3a and FIG. 3b are the structure diagrams showing a conventional third light source device.

FIG. 4a is a schematic diagram showing the first embodiment of the highly directional light source device of the present invention (1).

FIG. 4b is a schematic diagram showing the light scattering of the light emitting element of the first embodiment of the present invention.

FIG. 4c is a schematic diagram showing the first embodiment of the highly directional light source device of the present invention (2).

FIG. 4d is a schematic diagram showing the first embodiment of the highly directional light source device of the present invention (3).

FIG. 5 is a comparison diagram showing the energy obtained from experiments and simulations when the opening of the photon recycler of the highly directional light source device of the present invention is at 30 degrees.

FIG. 6 is the schematic diagram showing the second embodiment of the highly directional light source device of the present invention.

FIG. 7 is the schematic diagram showing the third embodiment of the highly directional light source device of the present invention.

FIG. 8 is the schematic diagram showing the fourth embodiment of the highly directional light source device of the present invention.

FIG. 9 is the schematic diagram showing the fifth embodiment of the highly directional light source device of the present invention.

FIG. 10 is the schematic diagram showing the sixth embodiment of the highly directional light source device of the present invention.

FIG. 11 is the schematic diagram showing the seventh embodiment of the highly directional light source device of the present invention.

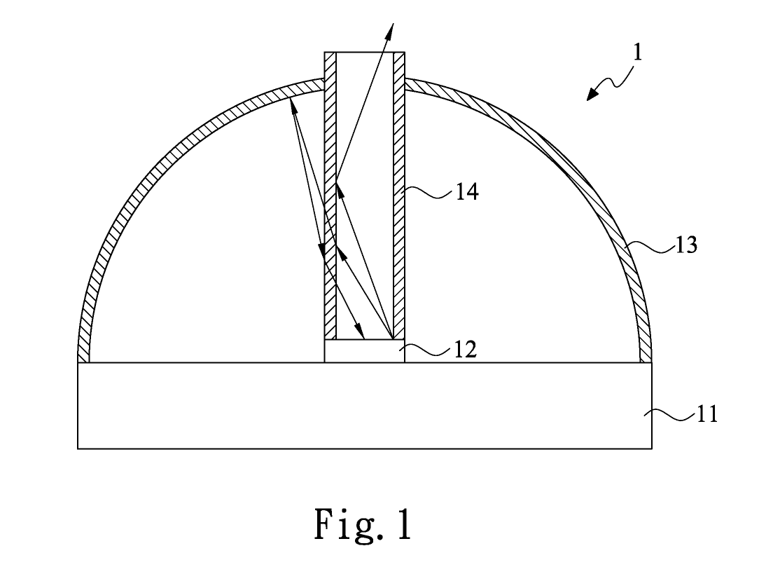

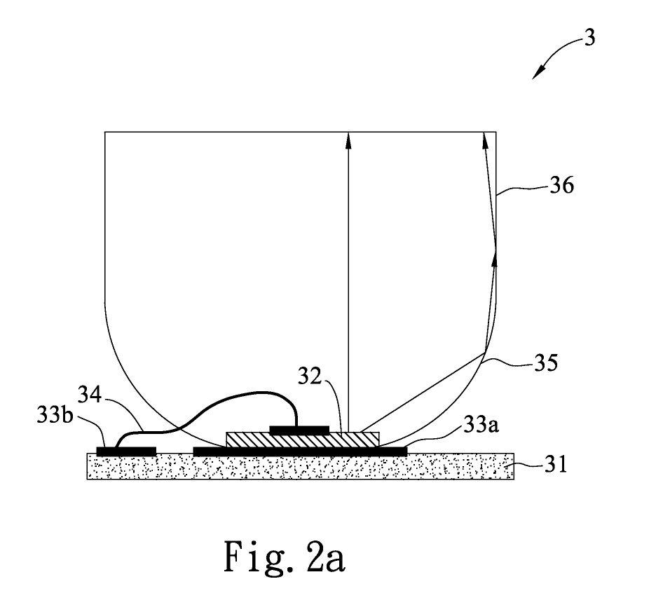

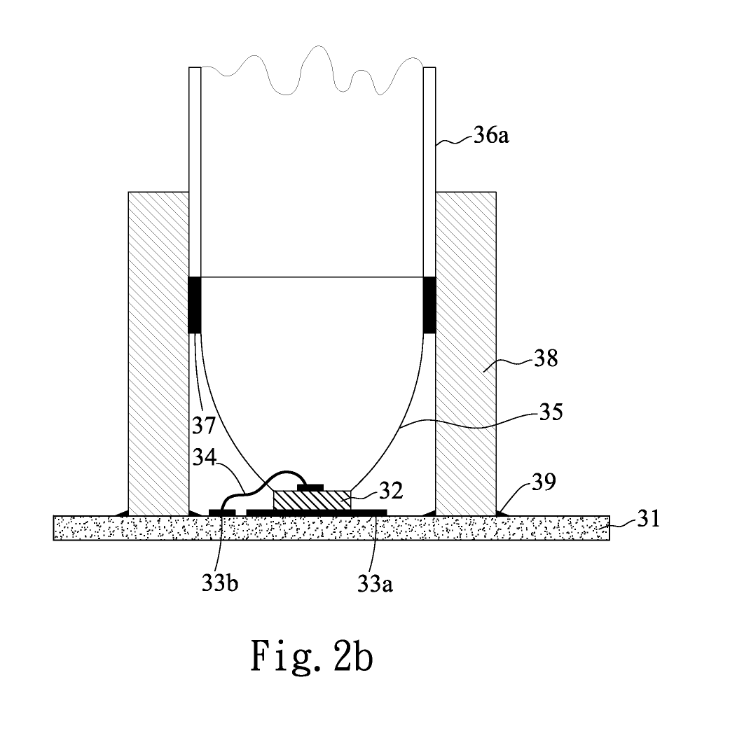

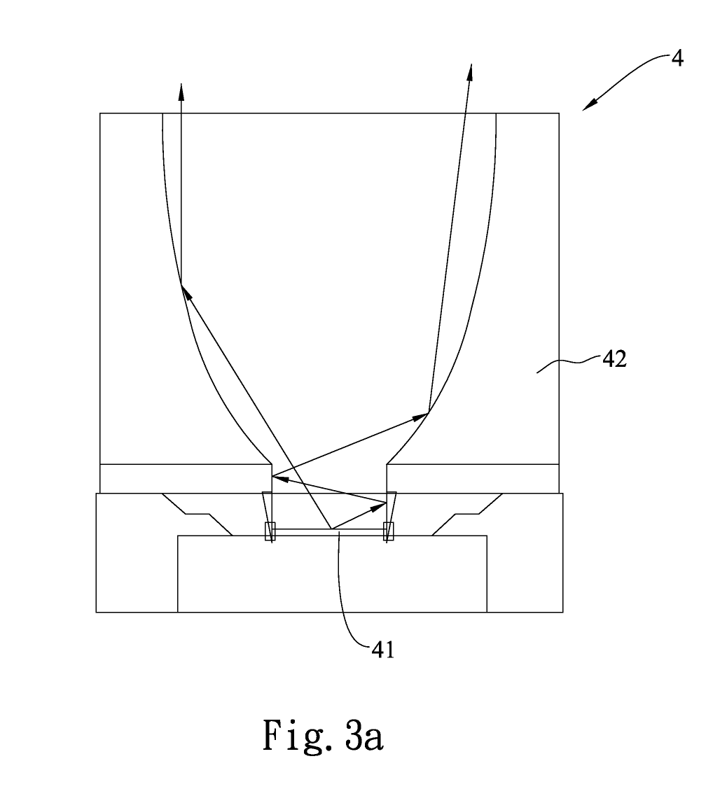

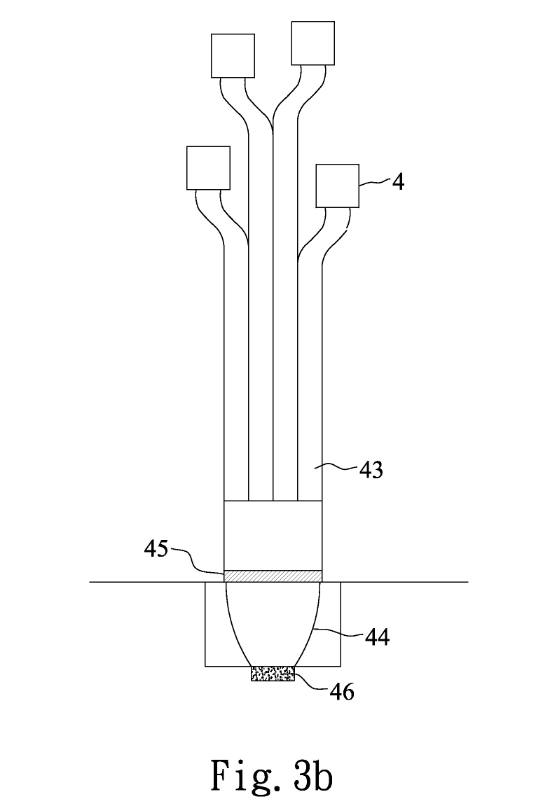

### DETAILED DESCRIPTION OF THE INVENTION

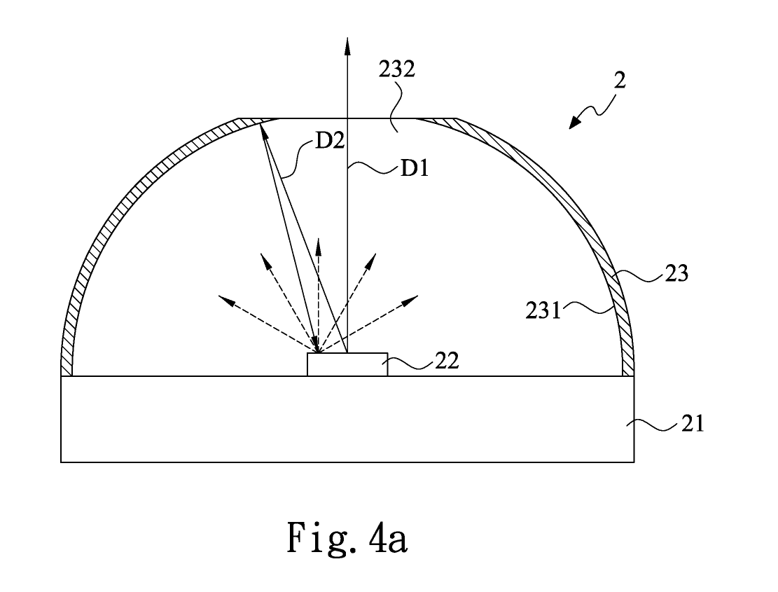

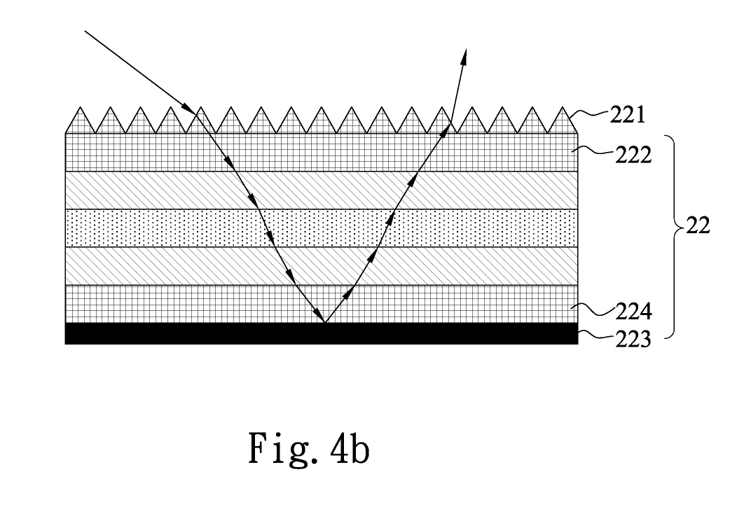

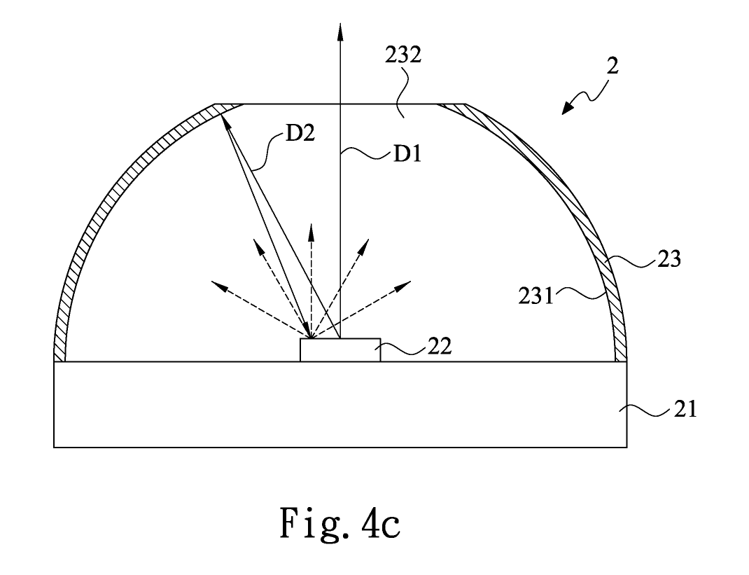

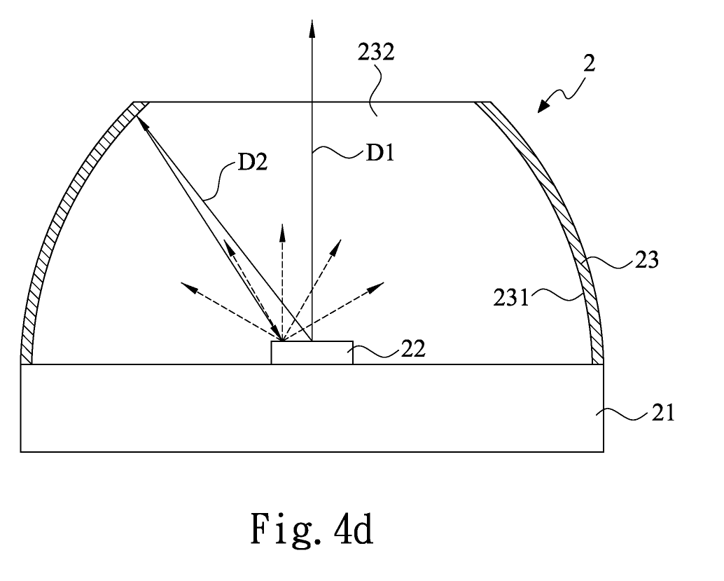

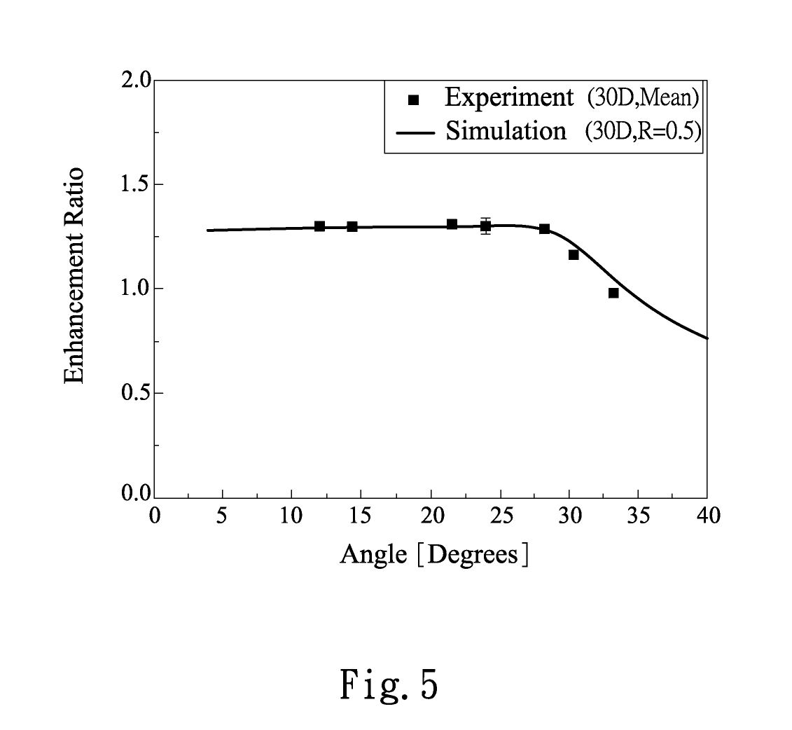

Please refer to FIG. 4a to FIG. 5, which are schematic diagrams showing the first embodiment of the highly directional light source device of the present invention. The highly directional light source device includes a substrate 21, a light emitting element 22 and a photon recycler 23. This light emitting element 22 is electrically connected on the substrate 21 to produce a light, the photon recycler 23 is set on one side of the substrate 21 and allows for the light emitting element 22 to be accommodated inside, and this photon recycler 23 has a reflective surface 231 on the inside section. An opening 232 is set on photo recycler 23, which corresponds to the central part of photo recycler 23 and is above the light emitting element 22, and wherein the light emitting element 22 is a layered structure having a surface microstructure 221, a first dielectric layer 222 and a reflective layer 223.

In this embodiment, the surface microstructure 221 is set on one side of the first dielectric layer 222, and is formed as a zigzag shape by etching, thereby the light produced from the light emitting element 22 can be scattered and refracted through the surface microstructure 221.

In this embodiment, the reflective layer 223 is set at the bottom of the light emitting element 22 so as to reflect the light refracted from the surface microstructure 221 and the first dielectric layer 222.

Furthermore, not only can the surface microstructure 221 be set on one side of the first dielectric layer, but the surface microstructure 221 can also be set on one side of the reflective layer 223, or the surface microstructure 221 can be set on one side of the second dielectric layer 224 of the light emitting element 22 (not shown in the figure) so as to refract and reflect the light of the light emitting element 22 reflected from the reflective surface 231 of the photon recycler 23.

In this embodiment, the bottom of the photon recycler 23 is set on one side of the substrate 21, the diameter of the bottom being 2 to 50 times the side length of the light emitting element 22.

In this embodiment, the angular range of the opening 232 of the photon recycler 23 is in a range from 1 to 50 degrees, and the preferred angular range of the opening 232 is in a range from 10 to 30 degrees.

When the highly directional light source device 2 operates, one part of the light produced from the light emitting element 22 will be along path D1 and be directly emitted out of the opening 232 of the photon recycler 23 which corresponds with the light element 22. Another part of the light will be along path D2 and will be reflected from the reflective surface 231 of the photon recycler 23 to the light emitting element 22, and after scattering or reflecting through the light emitting element 22, this light is emitted out of the opening 232.

In this embodiment, the reflective surface 231 is one selected from a spherical surface and an ellipsoid surface.

In the process of the reflection or refraction off the light emitting element 22, part of the light is received from the reflective surface 231 of the photon recycler 23, and then the light is refracted off the surface microstructure 221 of the light emitting element 22. That is, the light is refracted from the zigzag structure on the surface microstructure 221 so as to refract the other part of the light to the first dielectric layer 222 of the light emitting element 22 through the phenomenon of refraction. The first dielectric layer 222 then refracts the light to the reflective layer 223, and after being reflected from the reflective layer 223, refraction again proceeds off the first dielectric layer 222. Finally the light is refracted from the surface microstructure 221, thus allowing for the other part of the light to pass through the opening 232 along the route D1, and to be emitted out of the photon recycler 23. Thereby increased Étendue of the highly directional light source device 2 is achieved, as well as the goal of effective light emission.

Furthermore, during the scattering or reflecting process of the light emitting element 22, the other part of the light will be affected by the relationship of the layer shaped structure of the light emitting element 22 letting the other part of the light be shifted off the original path, which then forms a small angle of light. The path of the other part of the light after being scattered, will be different to the path of this part of this small angle of light, thereby resulting in more even light.

Also, regarding this other part of the light in the reflecting process, if the scattered angle of the light is bigger, then the ratio of the light reflected back to light emitting element 22 is smaller, which will affect the light emission efficiency of the highly directional light source device 2. Therefore, in order to increase the light emission efficiency, it is necessary to adjust the structure of the highly directional light source device 2.

In this embodiment, the angular ranges of the opening 232 at the top of the photon recycler 23 are respectively designed at 10 degrees, 20 degrees and 30 degrees. When the angle of the opening 232 is 10 degrees (as shown in FIG. 4a), the Étendue and light emission efficiency generated from the highly directional light source device 2 becomes respectively less; if the angle of the opening 232 increases from 10 degrees to 20 degrees (as shown in FIG. 4c), the Étendue and light emission efficiency generated from the highly directional light source device 2 increases slightly; if the angle of the opening 232 increases from 20 degrees to 30 degrees (as shown in FIG. 4d), then the Étendue and light emission efficiency generated from the highly directional light source device 2 are the most ideal.

FIG. 5 is a comparison diagram showing the energy and data obtained by experiments and simulations when the opening 232 of the highly directional light source of the present invention is at the angle of 30 degrees. The energy data and energy diagrams obtained by simulation and experiments, can be calculated according to the following formula:

$$Enhancement Ratio = \frac{Power in Selected Light Cone ( Case b )}{Power in Selected Light Cone ( Case a )}$$

The energy can be calculated by the formula when the angle of the opening 232 is 30 degrees or less and by comparing all energies (Case a) of the light emission element 22 being 30 degrees or less, with the energy (Case b) output through the center aperture of the photon recycler 23 being 30 degrees or less. The data obtained of the energy output from the center aperture of the photon recycler 23 from the experiment is better than the data obtained from simulation.

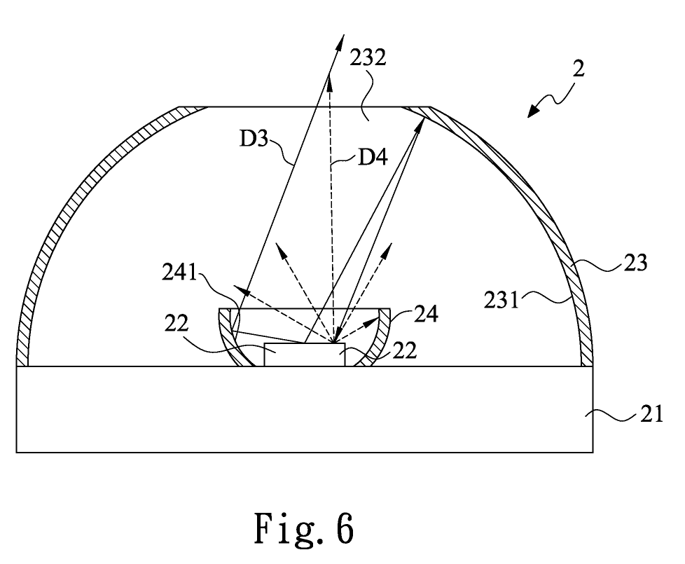

Please refer to FIG. 6, which is the schematic diagram showing the second embodiment of the highly directional light source device of the present invention, where this central portion of the substrate 21 of the highly directional light source device 2 has an additional light condensing element 24 with a light condensing surface 241 installed thereon, and the light emitting element 22 is set inside the light condensing element 24, and covers the outer edge of the light-emitting device 22, thereby allowing the light of the large divergence angle produced by the light emitting element 22 to be reflected from the light condensing element 24 and to be emitted out through the opening 232 of the photon recycler 23 directly along the path of D3. The light of the small divergence angle formed by the small offset angle is reflected through the photon recycler 23, and is then scattered or reflected through the internal structure of the light emitting element 22, allowing for the light after scattering or reflecting to be condensed through the light emitting element 24, and to be emitted out through the opening 232 of the proton recycler 23 along the path of D4, so as to achieve the purpose of increasing the light emission efficiency of the highly directional light source device 2.

In this embodiment, the light condensing surface 241 is a parabolic surface.

And the highly directional light source device 2 is applied in a flashlight or a projector.

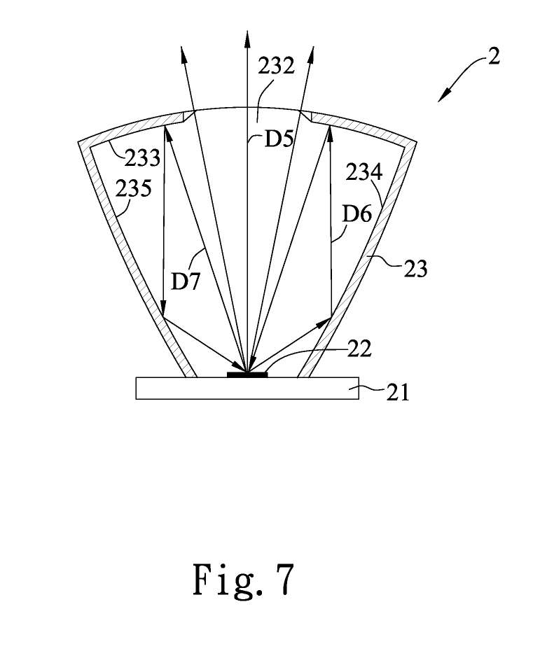

Please refer to FIG. 7, which is the schematic diagram showing the third embodiment of the highly directional light source device of the present invention.

Modifying the structure of the photon recycler 23 so that two sides inside the photon recycler 23 have the light condensing surface 241 of the light condensing element 24 as shown in FIG. 6. A top parabolic reflective surface 233 is set on the inner surfaces on two sides of the opening 232 and the top of the photon recycler 23, and two long and narrow shaped inner surfaces on the right and left sides inside the photon recycler 23 are respectively a first parabolic light condensing surface 234 and a second parabolic light condensing surface 235.

The first light produced by the light emitting element 22 is directly emitted out along the path of D5, that is, this first light is directly emitted through the opening 232 of the photon recycler 23.

Furthermore, the second light produced by the light emitting element 22 is emitted along the path of D6, that is, this second light is condensed and reflected to the top parabolic reflective surface 233 through the first parabolic light condensing surface 234 on one side of the photon recycler 23. Then the second light is reflected back to the light emitting element 22 for scattering through the top parabolic reflective surface 233, and is finally emitted out through the opening 232 of the light emitting element 22.

Moreover, the third light produced by the light emitting element 22 is emitted along the path of D7, that is, this third light is reflected to the second parabolic light condensing surface 235 through the top parabolic reflective surface 233 of the photon recycler 23, and is then reflected back to the light emitting element 22 for scattering through the second parabolic light condensing surface 235, and is finally emitted out through the opening 232 of the light emitting element 23.

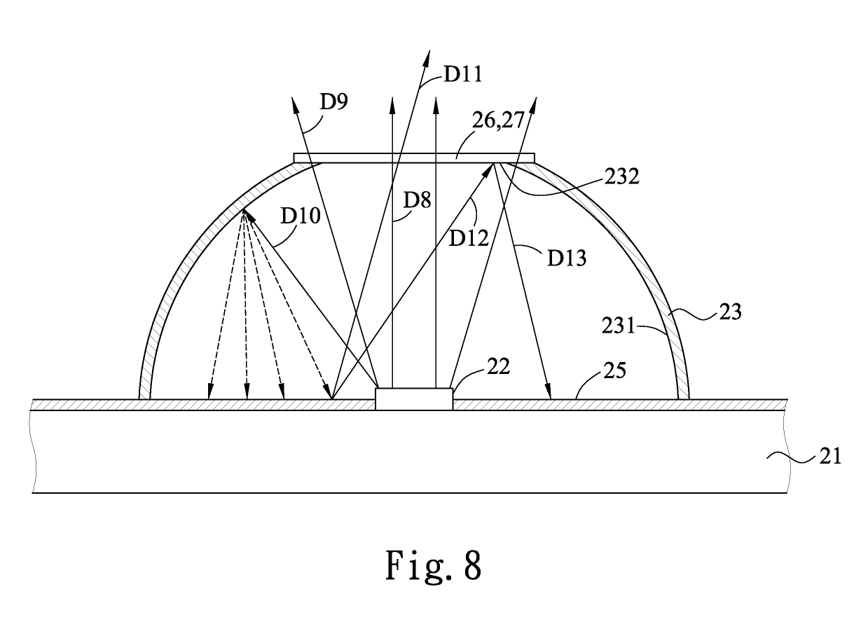

Please refer to FIG. 8, which is the schematic diagram showing the fourth embodiment of the highly directional light source device of the present invention. Based on the above mentioned first embodiment, a microstructure scattering layer 25 is set on one side of the substrate 21, and a light conversion element 26 is set at the opening 232 of the photon recycler 23.

The light conversion element 26 is a light conversion layer. When the light is produced by the light emitting element 22, the light forms a path of D8 and a path of D9 that passes through the opening 232 to this light conversion element 26, and through the light conversion layer on the light conversion element 26, the light with a small angle for projection is selected. The light with a large angle is emitted to reflective surface 231 of the photon recycler 23 along the path of D10, and is then reflected to the microstructure scattering layer 25, and then reflected to the light conversion element 26 through the microstructure scattering layer 25. The light is then emitted out through the light conversion element 26 (path D11), or again reflected to the microstructure scattering layer 25 through the light conversion element 26 (as path D12 and path D13), and then reflected from the microstructure scattering layer 25. Finally the light is emitted out through the above mentioned elements, thereby increasing both the Étendue and the efficiency of light emission.

The light conversion element 26 is one selected from a phosphor film, a semiconductor quantum dot, a semiconductor nanowire or a semiconductor quantum well.

Additionally, an angle selective membrane 27 (its position is the same as the light conversion element 26) can be set at the opening 232 of the photon recycler 23 for reflecting the large angle light rays of the light produced from the light emitting element 22, so as to directly let the small angle light rays of the light pass through.

Furthermore, as mentioned above, the microstructure scattering layer 25 not only can be set on one side of the substrate 21 and be limited to reflecting and scattering of the light, but also the microstructure scattering layer 25 can be set on the second dielectric layer of the light emitting element 22 (not shown in the figure). This allows the light from the reflective surface 231 of the photon recycler 23 to be reflected, or the light reflected through the light conversion element 26 to be reflected to the inside of this light emitting element 22 so as to proceed with refraction and scattering, thereby increasing the Étendue of the highly directional light source device.

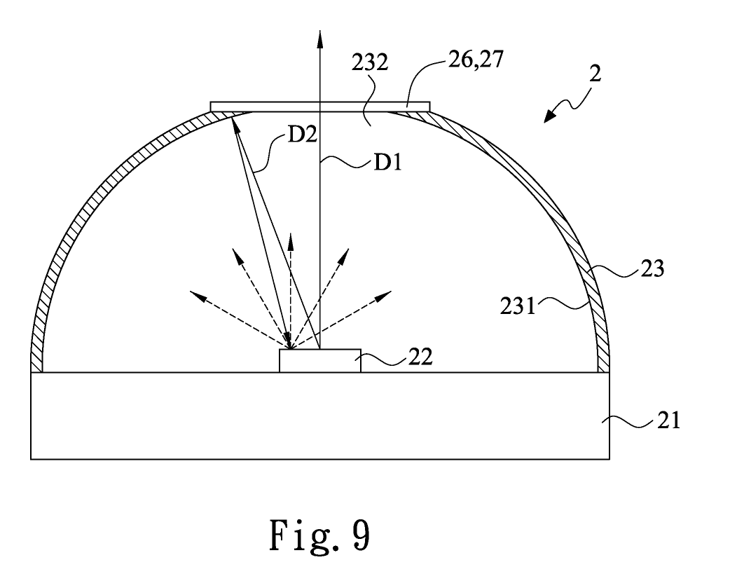

Please refer to FIG. 9, which is the schematic diagram showing the fifth embodiment of the highly directional light source device of the present invention. Based on the above mentioned first embodiment, the light conversion element 26 is additionally installed at the opening 232 of the photon recycler 23. Since the light transmission path is the same as the above mentioned, it will not be reiterated again.

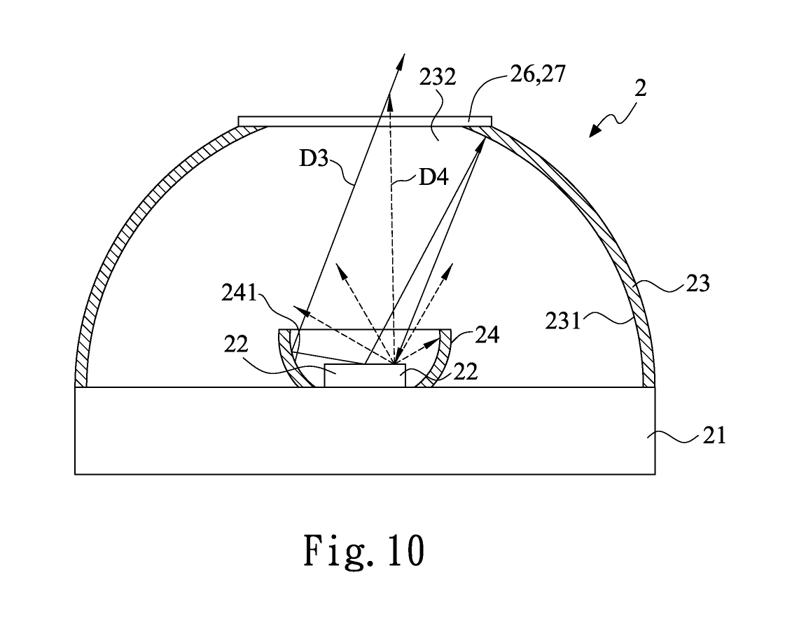

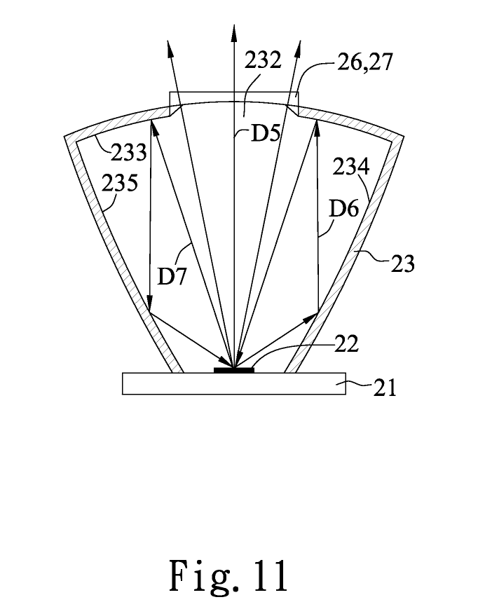

Please refer to FIG. 10, which is the schematic diagram showing the sixth embodiment of the highly directional light source device of the present invention. Based on the above mentioned second embodiment, the light conversion element 26 is additionally installed at the opening 232 of the photon recycler 23, and also the microstructure scattering layer 25 can be set on one side of the substrate 21, or on the second dielectric layer of the light emitting element 22 (not shown in the figure). Since the light transmission path is the same as the above mentioned, it will not be repeated again. Please refer to FIG. 11, which is the schematic diagram showing the seventh embodiment of the highly directional light source device of the present invention. Based on the above mentioned third embodiment, the light conversion element 26 is additionally installed at the opening 232 of the photon recycler 23, and the micro structure scattering layer 25 can be set on one side of the substrate 21, or on the second dielectric layer of the light emitting element 22 (not shown in the figure). Since the light transmission path is the same as the above mentioned, it will not be repeated again.

By the same token, the highly directional light source device 2 of the present invention emits the light produced by the light emitting element 22 directly out through the opening 232 of the photon recycler 23, and then reflects the light from the reflective surface 231 of the photon recycler 23 to the light emitting element 22. The reflected light is then scattered through the emitting element 22, and thereafter the light is emitted out of the opening 232 of the photon recycler 23, thereby achieving increased Étendue of the highly directional light source device and achieving the goal of effective light emission.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A directional light source device, comprising:
a substrate;
a light emitting element for producing a light, and
a photon recycler having a reflective surface for reflecting the light and an opening for emitting rays.

2. The directional light source device of claim 1, wherein the light emitting element comprises a microstructure set on one side of a first dielectric layer which can reflect and refract the light.

3. The directional light source device of claim 2, wherein the light emitting element further comprises a reflective layer, set at a bottom of the light emitting element so as to reflect the light.

4. The directional light source device of claim 1, wherein an angular range of the opening of the photon recycler is in a range from 1 to 50 degrees.

5. The directional light source device of claim 1, wherein the substrate further comprises a microstructure scattering layer for refracting and reflecting the light reflected from the photon recycler.

6. The directional light source device of claim 1, further comprising a light conversion element set at the opening of the photon recycler, and a microstructure scattering layer set on one of a second dielectric layer of the light emitting element and one side of the substrate, so as to further reflect and scatter after the light reflected from the photon recycler or the light conversion element.

7. The directional light source device of claim 1, wherein inner surfaces of two sides of the opening situated at the top of the photon recycler is a top parabolic reflective surface.

8. The directional light source device of claim 1, wherein two long and narrow shape inner surfaces of right and left sides inside the photon recycler are respectively a first parabolic light condensing surface and a second parabolic light condensing surface.

9. The directional light source device of claim 1, further comprising an angle selective membrane set at the opening of the photon recycler for reflecting large angle light rays of the light and which allows small angle light rays of the light to directly pass through, and the reflective surface is one selected from the group consisting of a spherical surface and an ellipsoid surface.

10. A highly directional light source device, comprising:
a substrate;
a light emitting element for producing a light;
a first photon recycler having a reflective surface for reflecting the light and accommodating the light emitting element inside, and setting an opening which corresponds with a portion of a top of the light emitting element, and
a second photon recycler, covering an outer edge of the light emitting element and having a reflective surface for receiving the light reflected from the first photon recycler and the light emitting from the light emitting element.

11. The directional light source device of claim 10, wherein the light condensing surface is a parabolic surface.

12. The directional light source device of claim 10, wherein the light emitting element comprises a surface microstructure set on one side of a first dielectric layer and forming a zigzag shape by etching so as to scatter and refract for the light produced by the light emitting element, and a reflective layer set at the bottom of the light emitting element so as to reflect the light.

13. The directional light source device of claim 10, wherein the angular range of the opening of the photon recycler is in a range from 1 to 50 degrees, and the preferred angular range of the opening is in a range from 10 to 30 degrees.

14. The directional light source device of claim 10, wherein the reflective surface is one selected from the group consisting of a spherical surface and an ellipsoid surface.

15. The directional light source device of claim 10, further comprising a light conversion element set at the opening of the photon recycler.

16. The directional light source device of claim 15, further comprising a microstructure scattering layer, setting on one of a second dielectric layer of the light emitting element and one side of the substrate, so as to proceed with reflection or scattering of the light after the light has passed through the photon recycler or been reflected from the light conversion element.
